(19) United States
(12) Patent Application Publication
(10) Pub. No.: US 2008/0311865 A1
(43) Pub. Date: Dec. 18, 2008

(54) Transmission scheduling control of average transmit signal power

(75) Inventors: Patrick Worfolk, Campbell, CA (US); Adam L. Schwartz, San Carlos, CA (US)

Correspondence Address: TZero Patent Dept., P.O. Box 641867, San Jose, CA, 95164-1867, US

(73) Assignee: TZero Technologies, Inc.

(21) Appl. No.: 11/818,361

(22) Filed: Jun. 14, 2007

(51) Int. Cl. H04B 17/00; H04B 1/04; H04J 3/00

(52) U.S. Cl. 455/115.1; 370/336; 455/127.1

(57) ABSTRACT

A method and apparatus for a method of transmitting information is disclosed. The method includes analyzing information to be transmitted. Transmit time durations are set based upon the information to be transmitted. A transmit signal power level is determined based on the transmit time durations, and a predetermined average transmit signal power threshold per predetermined period of time.

### FIELD OF THE DESCRIBE EMBODIMENTS

The invention relates generally to communication systems. More particularly, the invention relates to a method and apparatus for transmission scheduling control of average transmit signal power.

### BACKGROUND

Ultra-wideband (UWB) modulation provides very low-powered, high data rate radio communications for transferring data using very wide modulation bandwidths. FIG. 1 shows a typical application of UWB communication links used for indoor wireless communications. Several transceivers, for example, transceivers 110, 120, 130, 140 are networked allowing high bandwidth communications between the transceivers 110, 120, 130, 140. The transceivers 110, 120, 130, 140 can include, for example, a high definition television (HDTV) monitor networked with other devices, such as, a digital video recorder (DVR), a digital video disk (DVD) player and a computing device. The most common type of UWB is based on standards created by the WiMedia industry alliance.

The Federal Communications Committee (FCC) has mandated that UWB radio transmission can legally operate in the frequency range of 3.1 GHz to 10.6 GHz. Accordingly, the transmit power requirement for UWB communications is that the maximum average transmit Effective Isotropic Radiated Power (EIRP) is −41.3 dBm/MHz in any transmit direction averaged over any 1 mS interval.

Due to the lower transmit power levels required of UWB radio transmission, it is desirable to maximize the transmit power of the UWB transmission signals without exceeding the FCC mandated rules. Generally, SNR and associated communication transmission signal quality parameters improve with increased transmission signal power.

It is desirable to have a method and apparatus for providing high-power transmission signals within a UWB networking environment without exceeding FCC radiated power requirements.

### SUMMARY

An embodiment includes a method of transmitting information. The method includes analyzing information to be transmitted. Transmit time durations are set based upon the information to be transmitted. A transmit signal power level is determined based on the transmit time durations, and a predetermined average transmit signal power threshold per predetermined period of time.

Another embodiment of the invention includes a method of scheduling transmission of packets of information within a WiMedia super-frame. The method includes analyzing the packets of information to be transmitted. One of a finite number available transmit duty cycles is selected based upon the information to be transmitted. A transmit signal power level is determined based on the transmit duty cycle and a predetermined average transmit signal power threshold per predetermined period of time.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a typical application of UWB communication links used for indoor wireless communications.

FIG. 2A shows an example of a high-duty cycle signal (high relative to the signal shown in FIG. 2B) in the time-domain.

FIG. 2B shows an example of a low-duty cycle signal (low relative to the signal shown in FIG. 2B) in the time-domain.

FIG. 3 is a flow chart that shows an example of steps included within an embodiment of method of scheduling transmission.

FIG. 4 shows an example of a WiMedia super-frame.

FIG. 5 is a flow chart that shows an example of steps included within an embodiment of method of scheduling transmission of packets of information within a WiMedia super-frame.

FIG. 6 shows an example of a time-line of packets scheduled for transmission.

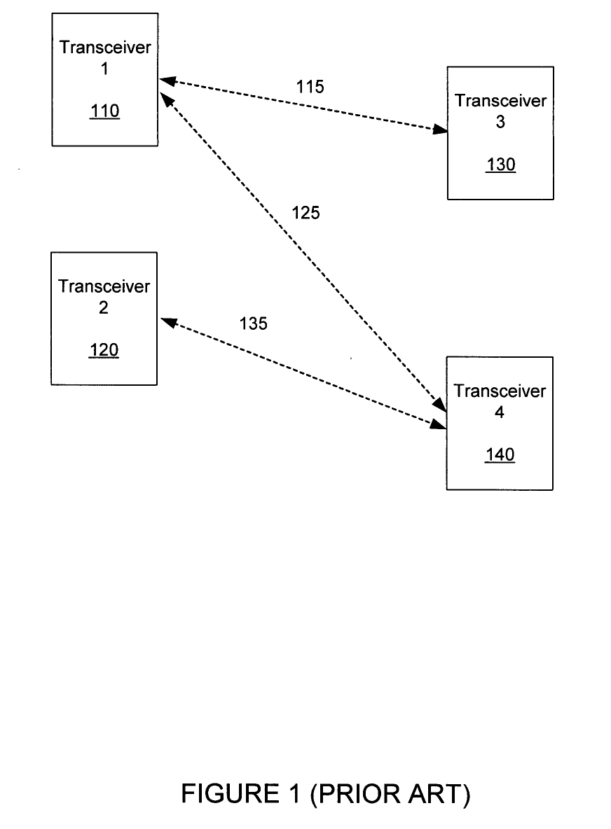

### DETAILED DESCRIPTION

The embodiments described include various methods of scheduling transmission of packets. The methods provide control of transmission signal power level of a transmitter. More specifically, the embodiments described can be used to control the average output power of a transmitter (for example, a UWB transmitter).

RMS Power

The average power of a signal can be defined as:

$${p}_{ave} = \frac{1}{τ} {\int }_{{t}_{0}}^{{t}_{0} + τ} p ( t ) d t$$

where p(t) is the instantaneous power, τ is a pre-determined duration of the averaging and t₀ is an arbitrary starting time for the measurement.

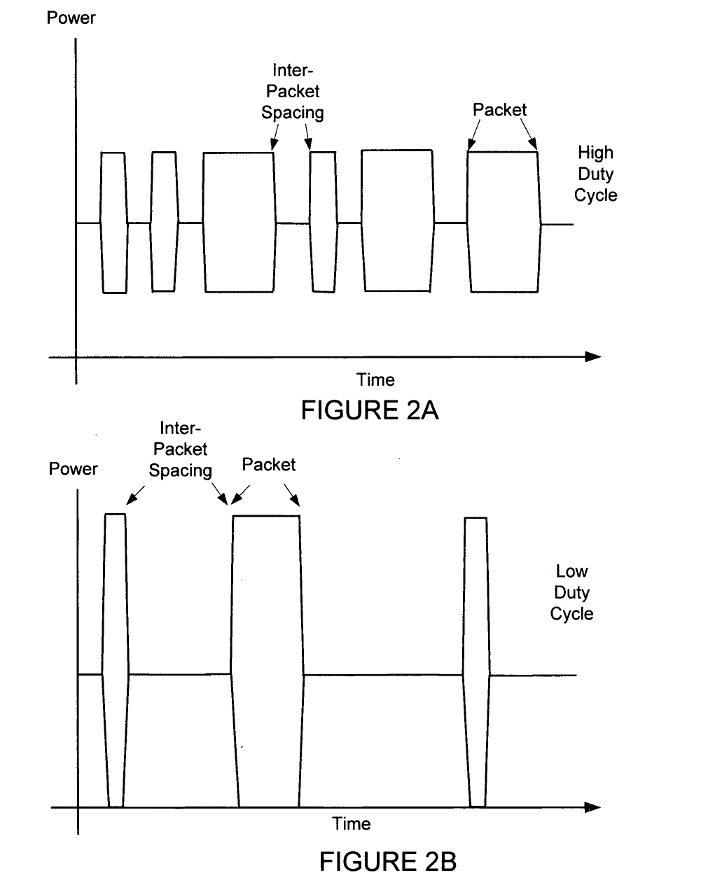

FIG. 2A shows an example of a high-duty cycle signal (high relative to the signal shown in FIG. 2B) in the time-domain. As shown, the exemplary transmission signal includes “on” periods of time (designated as “Packet”) and “off” periods of time (designated as “Inter-Packet Spacing”). The duty cycle of the transmission signal can generally be estimated as the ratio of the “on” periods to the sum of the “on” periods and the “off” periods over a predetermined period of time τ. For a UWB transmitter, the larger the duty cycle, the lower the target power level must be to satisfy the EiRP transmitted power regulations of UWB signals. The target power level can be defined as the level p(t) averaged over a period of time much shorter than τ ensuring pₐᵥₑ meets the regulation. That is, assuming that p(t) is roughly stationary (from a statistical perspective), then adjusting the instantaneous power p(t) to be equal to or less than the target power ensures that the power regulation is met.

FIG. 2B shows an example of a low-duty cycle signal (low relative to the signal shown in FIG. 2B) in the time-domain. As shown, the exemplary transmission signal includes “on” periods of time (designated as “Packet”) and “off” periods of time (designated as “Inter-Packet Spacing”). The duty cycle of the transmission signal can generally be estimated as the ratio of the “on” periods to the sum of the “on” periods and the “off” periods for the predefined period of time. For a UWB transmitter, the lower the duty cycle, the higher the target power level can be to satisfy the EiRP transmitted power restrictions of UWB signals.

As shown in FIGS. 2A and 2B, the UWB signals are bursty. This means that the signal energy is composed of packets which are of different durations and separated by different amounts of time. It can be deduced that that pₐᵥₑ depends not only on the instantaneous transmission power p(t) of the packets that are transmitted, but also on the inter-packet spacing during which time nothing is transmitted. In effect, the duty-cycle, g, of the transmitted signal to the inter-packet spacing scales the average power. In other words, during any interval of τ seconds,

pₐᵥₑ=g p_{packet}

where p_{packet} is an average power measurement of the signal taken during the “on” period of time while the transmission is actually occurring, and correspond to the instantaneous transmitted power. If, during τ seconds, the signal is transmitted 75% of the time, and nothing is transmitted during the remainder of the τ seconds, then g=0.75 and the average power is only ¾ of the packet power. The average transmitted power pₐᵥₑ is fixed by regulation. Therefore, once g is determined, the allowable instantaneous transmit power is given by;

p_{packet}=pₐᵥₑ/g

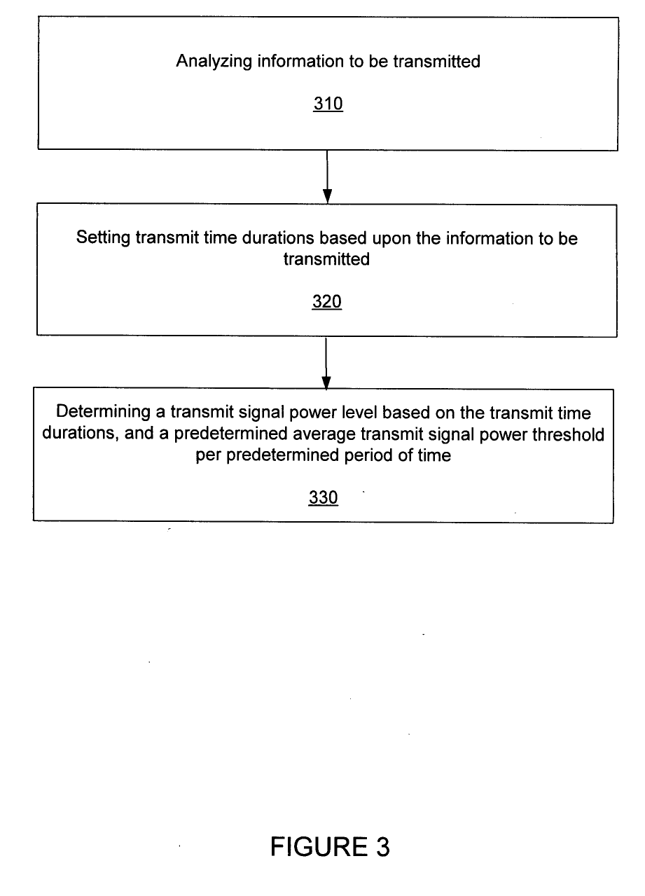

FIG. 3 is a flow chart that shows an example of steps included within an embodiment of a method of transmitting information. A first step 310 includes analyzing information to be transmitted. A second step 320 includes setting transmit time durations based upon the information to be transmitted. A third step 330 includes determining a transmit signal power level based on the transmit time durations, and a predetermined average transmit signal power threshold per predetermined period of time.

Generally, at least two types of information are transmitted. A first type of information includes beacons and acknowledgements, and a second type includes data. The beacons are typically of a relatively shorter duration and are transmitted according to a periodic schedule. For WiMedia, the duration of the beacons is limited to 63 us, and the period is 65 ms. The transmission power can be calculated accordingly. The transmit times of the beacons can be provided. Due to their relatively short duration, the beacons can typically be transmitted at near-maximum power. Acknowledgements are similar to beacons in that they occupy a very short duration of time, and therefore, can be transmitted at a relatively high transmission power level.

The transmit signal power is maintained under the predetermined average transmit signal power threshold p_{packet} per predetermined period of time τ. Therefore, the transmit power of the beacons and acknowledgements should also account for other signals being transmitted during the time τ. If no other signals (such as, data information) are transmitted during the predetermined period of time, the beacons and acknowledgements can generally be boosted in power level due to their short transmit time duration. The transmit power level of the beacon should be set to ensure the predetermined average transmit signal power threshold is not exceeded. More generally, signals that are transmitted with a known duty-cycle can be boosted by an amount inversely proportional to the know duty-cycle. One embodiment includes increasing the transmit power inversely proportional to a priori duty-cycle of the signal being transmitted.

There is typically more flexibility in manipulating the timing and power levels of data information than beacon or acknowledgement information. The actual data throughput is related to the data rate and the duty-cycle, wherein the data rate is the rate at which the data is transmitted during the “on” portion of the duty-cycle. If the duty-cycle is reduced for a given data rate the throughput drops. However, reducing the duty-cycle allows the transmit power to be increased. A higher transmit power improves the quality of the wireless link, allowing a higher data rate signal to be transmitted. This effectively counter-balances drops in throughput due to the reduced duty-cycle.

For data transmission, there are typically two reasons to adjust the duty-cycle. The first reason is motivated by achieving a desired throughput by increasing the transmit power and lowering the duty-cycle, resulting in improved spectral efficiency and increased overall network capacity. The second reason includes reducing the duty-cycle to improve the quality of a wireless link by increasing the transmit power.

Therefore, another embodiment includes determining a desired transmission data throughput, and selecting a minimum duty cycle for providing the desired transmission data throughput, wherein determining the duty cycle comprises dividing the transmit time duration during the predetermined period by τ. Generally, a link quality determines the signal quality of transmission signals traveling through the link. The signal quality generally sets of the order of modulation and level of coding of the transmission signals. Increasing the transmitted power improves the link quality and allows an increase in the bit rate of the transmitted signal. That is, the data rate can be increased by increasing the transmit power. The duty-cycle and the data rate are jointly select by adjustment of the transmit power to achieve the desired data throughput.

Another embodiment includes determining a desired transmission data throughput, selecting the transmit signal power level to minimize duty cycle, and selecting the transmit time duration per τ seconds for providing the desired transmission data throughput.

If the link quality is poor, an embodiment includes determining a transmit power require to maintain a desired transmission link quality, and setting the transmit time duration per predetermined τ seconds for maintaining the required transmit power and not exceeding the predetermined average transmit signal power threshold over τ seconds.

The described methods for setting transmit time durations and transmit signal power level can be implemented and controlled through the use of transmission scheduling. The transmission scheduling can control the duty cycles, transmit time durations, and transmit power levels of transceivers within the wireless network.

The transmission scheduling can be implemented with a MAC (media access control) scheduler that includes a continuous series of super-frames, such as, a WiMedia MAC super-frame. The super-frames can include time slots that are allocated to various devices for scheduled transmission within the network. As will be described, the structure of the super-frames more readily lend themselves to controlling transmit time durations in conformance (generally, multiples of) with the time durations of the time slots of the super-frames. Comparing the time duration of the time slots of the super-frame with the previously mentioned predetermined time period τ seconds, can yield natural cycles that can be used to determine transmit time duty cycles. For example, the UWB FCC regulation sets τ to be 1 ms. Additionally, the WiMedia MAC super-frame includes time slots that are 0.256 ms is duration. Therefore, a 25% duty cycle, a 50% duty cycle, a 75% duty cycle, and a 100% duty cycle can be set relatively simply.

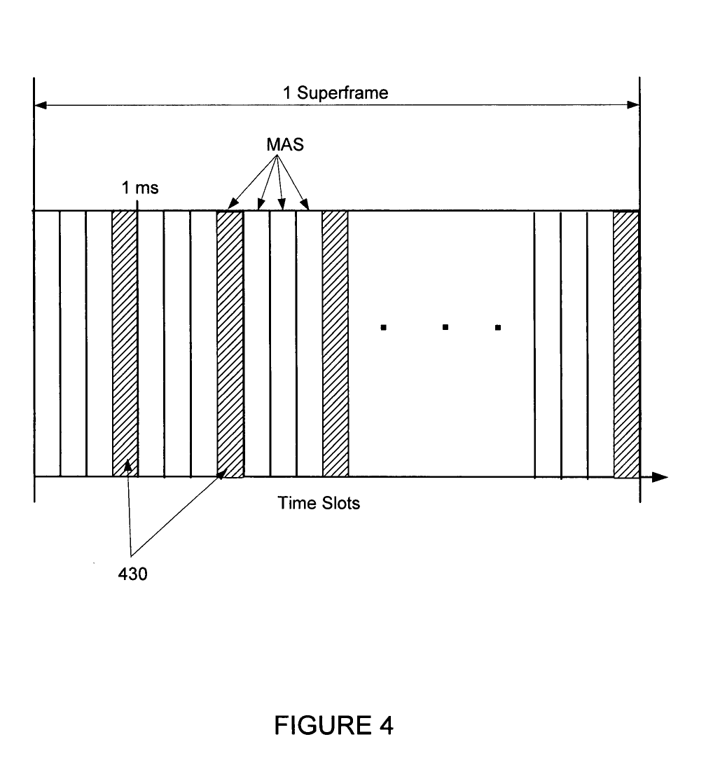

FIG. 4 shows an example of a WiMedia super-frame. The super-frame includes 256 medium access slots (MAS). Each MAS has a time duration of 256 us. The transmission of a transceiver that is controlled by the super-frame transmits follows a sequence as defined by the time axis.

One embodiment includes scheduling transmissions to occur in selected MAS(s) which provide the required duty-cycle. Natural duty cycles can be formed with ratios of 0.256/τ=0.256/1.00, or duty that are factors of approximately 25%. More specifically, natural duty cycles selections include 25%, 50%, 75% and 100%.

The transmitter can be scheduled, for example, to transmit data packets during the shaded MAS(s) 430 as shown. More specifically, the data packets are transmitted every fourth MAS. The result is a 25% duty cycle, allowing the transmit power to be approximately four times greater than it would be with a 100% duty cycle. As shown, the 50%, 75% and 100% duty cycles can easily be obtained by scheduling periodic schedules of additional slots.

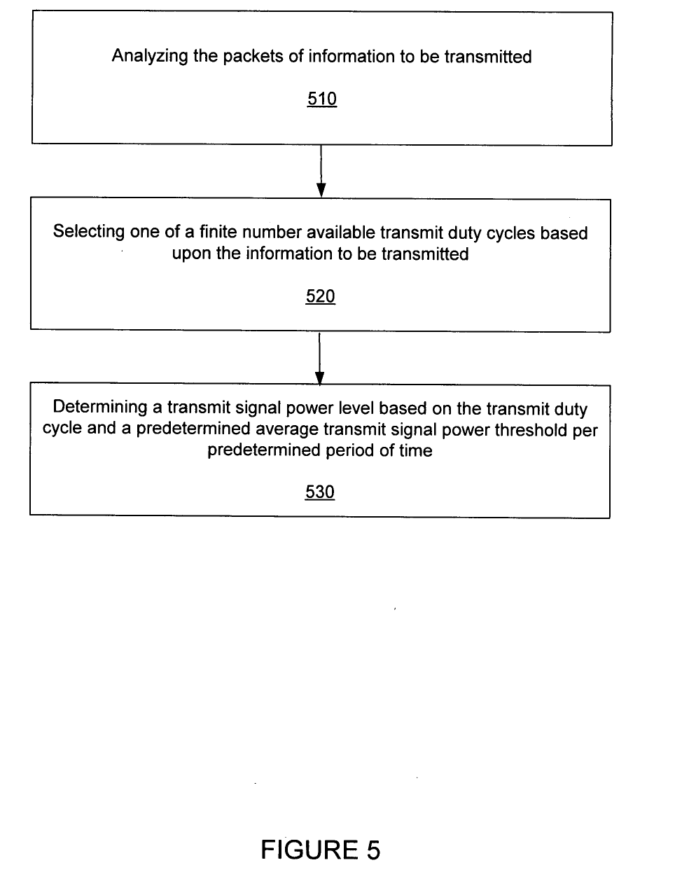

FIG. 5 is a flow chart that shows an example of steps included within an embodiment of scheduling transmission of packets of information within a WiMedia super-frame. A first step 510 includes analyzing the packets of information to be transmitted. A second step 520 includes selecting one of a finite number available transmit duty cycles based upon the information to be transmitted. A third step 530 includes determining a transmit signal power level based on the transmit duty cycle and a predetermined average transmit signal power threshold per predetermined period of time.

As previously described, the transmit time, or transmit signal duty cycle can be selected to achieve a desired data throughput or to allow for a transmission signal power for transmission over a poor quality link. One embodiment includes determining a desired transmission data throughput and selecting the transmit duty cycle for providing the desired transmission data throughput. Another embodiment includes determining a transmit power require to maintain a desired transmission link quality and selecting the transmit duty cycle for maintaining the required transmit power and not exceeding the average transmit signal power threshold per predetermined period of time. As previously described, and FCC driven predetermined period τ is 1 ms. A finite number available transmit duty cycles can include a 25% duty cycle, a 50% duty cycle, a 75% duty cycle, and a 100% duty cycle.

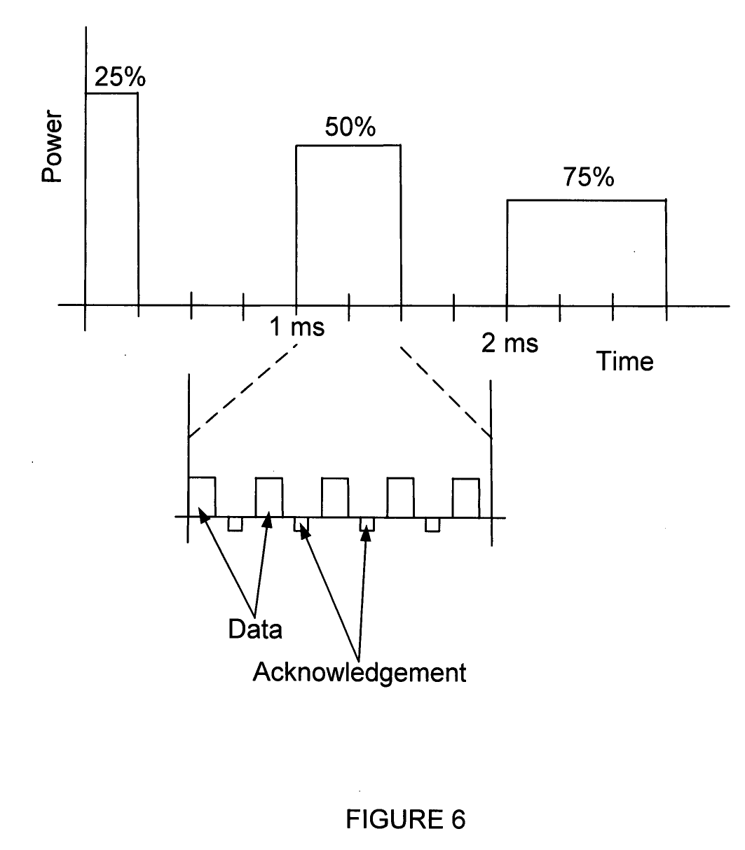

FIG. 6 shows an example of a time-line of packet scheduled for transmission. For example, 25%, 50% and 75% duty cycles are shown. During each slot selected for transmission, one or more data packets may be transmitted. If acknowledgements for the data packets are requested, then there are additional idle times. These additional idle times may also be taken into account when computing the maximum allowed transmit power. FIG. 6 shows the 50% duty cycle signal expanded to show multiple data packets, acknowledgements, and idle time (between data and acknowledgements).

Although specific embodiments of the invention have been described and illustrated, the invention is not to be limited to the specific forms or arrangements of parts so described and illustrated. The invention is limited only by the appended claims.

What is claimed:

1. A method of transmitting comprising:
analyzing information to be transmitted;
setting transmit time durations based upon the information to be transmitted;
determining a transmit signal power level based on the transmit time durations, and a predetermined average transmit signal power threshold per predetermined period of time.

2. The method of claim 1, wherein the information to be transmitted comprises beacons, and the transmit time durations of the beacons are provided.

3. The method of claim 2, wherein determining the transmit signal power level of the beacons further comprises accounting for all other signals being transmitted within the predetermined period of time, ensuring the predetermined average transmit signal power threshold is not exceeded.

4. The method of claim 1, wherein the information to be transmitted comprises acknowledgements, and the transmit time durations of the acknowledgements are provided.

5. The method of claim 4, wherein determining the transmit signal power level of the acknowledgements further comprises accounting for all other signals being transmitted within the predetermined period of time, ensuring the predetermined average transmit signal power threshold is not exceeded.

6. The method of claim 1, wherein the information to be transmitted comprises data.

7. The method of claim 6, further comprising:
determining a desired transmission data throughput;
selecting a minimum duty cycle for providing the desired transmission data throughput, wherein determining the duty cycle comprises dividing the transmit time duration during the predetermined period by the predetermined period.

8. The method of claim 6, further comprising:
determining a desired transmission data throughput;
selecting the transmit signal power level to minimize duty cycle;
selecting the transmit time duration per predetermined period of time for providing the desired transmission data throughput.

9. The method of claim 6, further comprising:
determining a transmit power require to maintain a desired transmission link quality;
setting the transmit time duration per predetermined period of time for maintaining the required transmit power and not exceeding the predetermined average transmit signal power threshold per predetermined period of time.

10. The method of claim 1, further comprising scheduling the transmit time duration according to a predetermined transmission scheduling super-frame.

11. The method of claim 10, further comprising selecting the transmit time duration from a finite set of available transmit time durations.

12. The method of claim 11, wherein the finite set of available transmit time durations are determined from natural time cycles of the predetermined period of time and a predetermined transmission scheduling super-frame.

13. The method of claim 12, wherein the predetermined period of time is 1 ms, and the super-frame is a Wimedia MAC super-frame.

14. The method of claim 13, wherein the finite set of available transmit time durations comprise a 25% duty cycle, a 50% duty cycle, a 75% duty cycle, and a 100% duty cycle.

15. A method of scheduling transmission of packets of information within a WiMedia super-frame, comprising:
analyzing the packets of information to be transmitted;
selecting one of a finite number available transmit duty cycles based upon the information to be transmitted;
determining a transmit signal power level based on the transmit duty cycle and a predetermined average transmit signal power threshold per predetermined period of time.

16. The method of claim 15, further comprising:
determining a desired transmission data throughput;
selecting the transmit duty cycle for providing the desired transmission data throughput.

17. The method of claim 13, further comprising:
determining a transmit power require to maintain a desired transmission link quality;
selecting the transmit duty cycle for maintaining the required transmit power and not exceeding the predetermined average transmit signal power threshold per predetermined period of time.

18. The method of claim 15, wherein the predetermined period of time is 1 ms.

19. The method of claim 15, wherein the finite number available transmit duty cycles comprise a 25% duty cycle, a 50% duty cycle, a 75% duty cycle, and a 100% duty cycle.

20. The method of claim 15, wherein the information to be transmitted comprises beacons, and the transmit time durations of the beacons are provided.

21. The method of claim 15, wherein the finite set of available transmit time durations are determined from natural time cycles of the predetermined period of time and a predetermined transmission scheduling super-frame.
